(19) United States
(12) Patent Application Publication
(10) Pub. No.: US 2006/0226233 A1
(43) Pub. Date: Oct. 12, 2006

(54) Scanners

(75) Inventor: Hua-Chun Tsai, Taipei City (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/394,297

(22) Filed: Mar. 29, 2006

(30) Foreign Application Priority Data
Mar. 30, 2005 (TW) TW94109993

(51) Int. Cl. G06K 7/10

(52) U.S. Cl. 235/472.01

(57) ABSTRACT

Scanners are provided. A scanner includes a housing, a scanning module, and a light source. The housing comprises a transparent plate bearing a target. The scanning module is movably disposed in the housing and scans the target through the transparent plate. The light source is disposed outside the scanning module and generates a light beam detectable by the scanning module.

### BACKGROUND

The invention relates to scanners.

Scanners are commonly used to scan documents or images, such that users can process the electronic documents or images on computers conveniently.

Generally, a scanner comprises a housing and a scanning module. The scanning module is disposed in the housing. The housing comprises a transparent plate bearing a document. The scanning module moves forward and backward to scan the document through the transparent plate. Typically, before a scan, the scanning module returns to an initial location to fully scan the document. The initial location is the location where the scanning module is located when the scanner is turned on.

In a conventional scanner, the housing has a specific pattern thereon, such as a bar code, disposed in a location corresponding to the initial location of the scanning module. Thus, the scanning module can determine whether it is in the initial location according to a captured image. If the captured image matches the specific pattern, it is determined that the scanning module is in the initial location. The document or dust on the transparent plate can, however, interfere with the specific pattern since the specific pattern is located in a scan area of the scanning module, such that the scanning module may mistakenly scan the document.

### SUMMARY

Scanners are provided. An exemplary embodiment of a scanner comprises a housing, a scanning module, and a light source. The housing comprises a transparent plate bearing a target. The scanning module is movably disposed in the housing and scans the target through the transparent plate. The light source is disposed outside the scanning module and generates a light beam detectable by the scanning module.

### DESCRIPTION OF THE DRAWINGS

The invention can be more fully understood by reading the subsequent detailed description and examples with references made to the accompanying drawings, wherein:

FIG. 1 is a diagram of an embodiment of a scanner, wherein a scanning module is in an initial location.

FIG. 2 is a schematic diagram of a charge coupled device (CCD) of a scanning module below a light exit area of a light guiding plate when the scanning module is in an initial location.

FIG. 3 is a diagram showing the back of a light guiding plate.

FIG. 4 is a diagram of an embodiment of a scanner, wherein a scanning module is not in an initial location.

### DETAILED DESCRIPTION

The invention is described in greater detail in the following.

A principle aim of the invention is to add a new light source to a scanner. The new light source is disposed outside a scanning module and a transparent plate generating a light beam detectable by the scanning module. The scanning module then determines whether it is substantially in an initial location according to strength of the detected light beam.

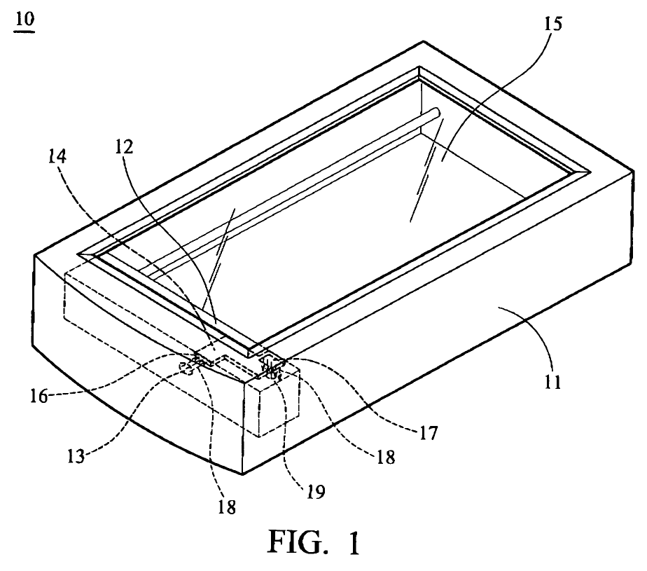

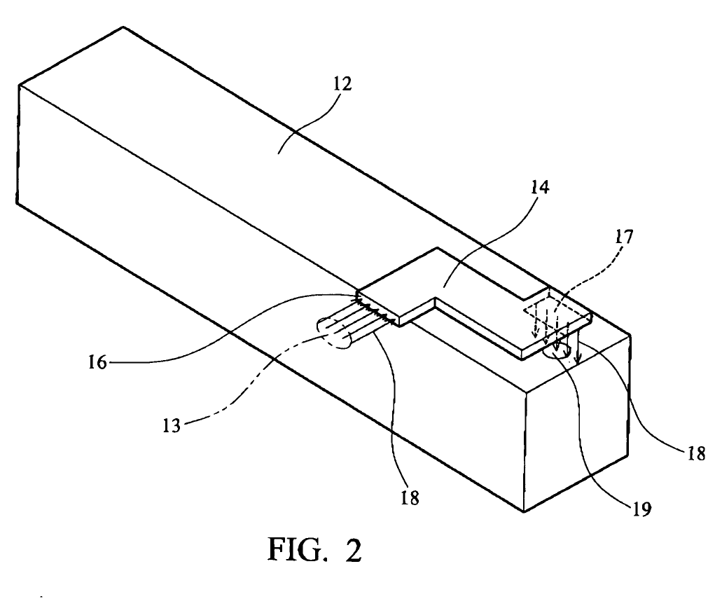

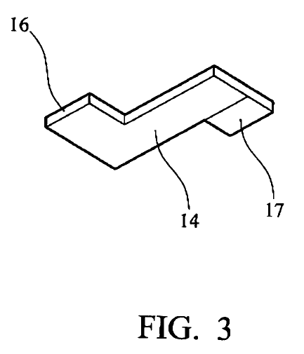

FIG. 1 is a diagram of an embodiment of a scanner 10, wherein a scanning module 12 is in an initial location. FIG. 2 is a schematic diagram of a charge coupled device (CCD) 19 of the scanning module 12 below a light exit area 17 of a light guiding plate 14 when the scanning module 12 is in the initial location. FIG. 3 is a diagram showing the back of the light guiding plate 14.

As shown in the drawings, the scanner 10 comprises a housing 11, a scanning module 12, a light source 13, and a light guiding plate 14.

The housing 11 comprises a transparent plate 15 bearing a document.

The scanning module 12 is disposed in the housing 11. The scanning module 12 can move forward and backward to scan the document through the transparent plate 15. Before a scan, the scanning module 12 returns to an initial location to fully scan the document. The initial location, as shown in FIG. 1, is the location where the scanning module 12 is located when the scanner 10 is turned on.

The light source 13 is fixed in the housing 11. The light source 13 is a light-emitting diode (LED) outside the scanning module 12 and the transparent plate 15. The light source 13 generates a light beam 18 detectable by the scanning module 12. The light beam 18 is monochromatic, such as green light. Frequency f of the light beam 18 is adjustable.

The light guiding plate 14 is fixed in the housing 11. The light guiding plate 14 comprises a light entrance area 16 and a light exit area 17. The light entrance area 16 is adjacent to the light source 13 to receive the light beam 18 generated by the light source 13. The light exit area 17 is outside the transparent plate 15. The light guiding plate 14 guides the light beam 18 to the light exit area 17. It is noted that the outer surface of the light guiding plate 14 is covered with light reflecting material except for the light entrance area 16 and the light exit area 17, forcing the light beam 18 to enter or exit the light guiding plate 14 only via the light entrance area 16 and the light exit area 17.

The scanning module 12 comprises a charge coupled device (CCD) 19. The CCD 19 can detect the light beam 19 generated by the light source 13 periodically according to the frequency f of the light beam 18 when necessary. The scanning module 12 thus determines whether it is substantially in the initial location according to strength of the detected light beam 18. If the strength exceeds a reference value, the scanning module 12 is substantially in the initial location, and vice versa.

When the scanning module 12 is in the initial location, as shown in FIG. 1, the CCD 19 is below the light exit area 17. The strength of the light beam 18 emitted from the light exit area 17 detected by the CCD 19 exceeds the reference value, so it is determined that the scanning module 12 is in the initial location exactly.

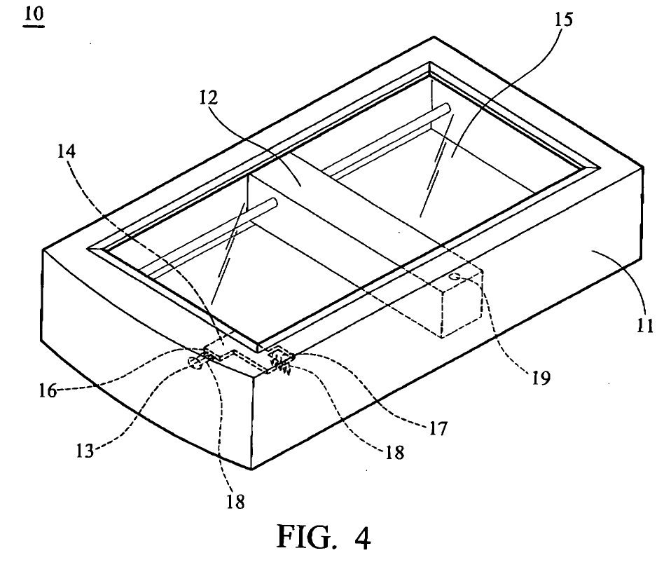

FIG. 4 is a diagram of an embodiment of the scanner 10, wherein the scanning module 12 is not in the initial location. As shown in FIG. 4, when the scanning module 12 is not in the initial location, the CCD 19 is not below the light exit area 17. The strength of the light beam 18 emitted from the light exit area 17 detected by the CCD 19 does not exceed the reference value, so it is determined that the scanning module 12 is not in the initial location.

In some embodiments, a new light source is added. The new light source is disposed outside a scanning module and a transparent plate generating a light beam detectable by the scanning module. The scanning module then determines whether it is substantially in an initial location according to strength of the detected light beam.

It is advantageous that a document or dust on the transparent plate can not interfere with the new light source because the new light source is disposed outside the transparent plate, thus preventing the scanning module from mistakenly scanning the document.

Moreover, because the light beam generated by the light source is monochromatic, a charge coupled device (CCD) of the scanning module needs only one channel to detect the light beam. The CCD can easily distinguish the light beam from normal images or documents, thus accelerating the process to determine whether the scanning module is in the initial location.

While the invention has been described in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scanner, comprising:
a housing comprising a transparent plate bearing a target;
a scanning module movably disposed in the housing scanning the target through the transparent plate; and
a light source disposed outside the scanning module generating a light beam detectable by the scanning module.

2. The scanner as claimed in claim 1, wherein the scanning module determines whether it is substantially in a first location according to the detected light beam.

3. The scanner as claimed in claim 2, wherein the scanning module determines whether it is substantially in the first location according to strength of the detected light beam.

4. The scanner as claimed in claim 2, wherein the first location is where the scanning module is located when the scanner is turned on.

5. The scanner as claimed in claim 1, wherein the light source is disposed in the housing.

6. The scanner as claimed in claim 1, wherein the light source is disposed outside the transparent plate.

7. The scanner as claimed in claim 1, wherein the scanning module comprises a charge coupled device (CCD) detecting the light beam generated by the light source.

8. The scanner as claimed in claim 1 further comprising a light guiding plate, wherein the light guiding plate comprises a light entrance area and a light exit area, the light entrance area is adjacent to the light source, the light exit area is outside the transparent plate, and the light guiding plate guides the light beam to the light exit area.

9. The scanner as claimed in claim 8, wherein the scanning module comprises a charge coupled device (CCD), and when the scanning module is in the first location, the CCD is below the light exit area and detects the light beam emitted from the light exit area.

10. The scanner as claimed in claim 1, wherein the light source is a light-emitting diode (LED).

11. The scanner as claimed in claim 1, wherein the light beam is monochromatic.

12. The scanner as claimed in claim 1, wherein frequency of the light beam is adjustable, and the scanning module detects the light beam generated by the light source according to the frequency of the light beam.
